(19) United States
(12) Patent Application Publication
(10) Pub. No.: US 2024/0071344 A1
(43) Pub. Date: Feb. 29, 2024

(54) MUSICAL INSTRUMENT

(71) Applicant: YAMAHA CORPORATION, Hamamatsu-shi (JP)

(72) Inventors: Jun ISHII, Hamamatsu-shi (JP); Kazuyuki IGARASHI, Tokyo (JP)

(21) Appl. No.: 18/503,733

(22) Filed: Nov. 7, 2023

Related U.S. Application Data
(63) Continuation of application No. PCT/JP2022/020352, filed on May 16, 2022.

(30) Foreign Application Priority Data
May 19, 2021 (JP) 2021-084966

(51) Int. Cl. G10H 1/34; G10B 3/12

(52) U.S. Cl. CPC G10H 1/34; G10B 3/12

(57) ABSTRACT

A musical instrument includes a fixed member; a movable member displaceable in response to a playing operation of the musical instrument, the movable member being displaceable relative to the fixed member from a first state where the movable member is in an initial position to a second state where the movable member is displaced from the initial position; a detectable circuit including a magnetic or conductive body and disposed on the movable member; and a detector circuit including a coil disposed on the fixed member and configured to output a detection signal corresponding to a voltage that is dependent on a distance between the detectable circuit and the coil. A distance between the detectable circuit and the coil in the first state is smaller than a distance between the detectable circuit and the coil in the second state.

### CROSS REFERENCE TO RELATED APPLICATIONS

This application is a Continuation Application of PCT Application No. PCT/JP2022/020352, filed on May 16, 2022, and is based on and claims priority from Japanese Patent Application No. 2021-084966, filed on May 19, 2021, the entire contents of each of which are incorporated herein by reference.

### TECHNICAL FIELD

The present disclosure relates to musical instruments.

### BACKGROUND

Various techniques for detecting displacement of a movable member such as a key in a keyboard musical instrument have been proposed. For example, Japanese Patent Application Laid-Open Publication No. 2021-508399 discloses a configuration for detecting a position of a movable member by using an excitation coil and a position detection coil installed on a fixed member, and an excitable coil installed in the movable member that moves relative to the fixed member. In this technique, a reference signal is supplied to the excitation coil, and the position of the movable member is detected in accordance with the amplitude of the detection signal output from the position detection coil.

The conventional technique suffers from a drawback in that unwanted radiation noise is caused upon generation of a detection signal.

### SUMMARY

An object of the present disclosure is to minimize such unwanted radiation noise caused by detection signals.

In order to solve the above problem, a musical instrument according to an aspect of the present disclosure includes a fixed member; a movable member displaceable in response to a playing operation of the musical instrument, the movable member being displaceable relative to the fixed member from a first state where the movable member is in an initial position to a second state where the movable member is displaced from the initial position; a detectable circuit including a magnetic or conductive body and disposed on the movable member; and a detector circuit including a coil disposed on the fixed member and configured to output a detection signal corresponding to a voltage that is dependent on a distance between the detectable circuit and the coil, in which a distance between the detectable circuit and the coil in the first state is smaller than a distance between the detectable circuit and the coil in the second state.

### BRIEF DESCRIPTION OF THE DRAWINGS

FIG. 1 is a block diagram illustrating a configuration of a keyboard musical instrument according to a first embodiment.

FIG. 2 is a block diagram illustrating a configuration of a keyboard musical instrument.

FIG. 3 is a circuit diagram of a detector circuit and a detectable circuit.

FIG. 4 is a block diagram illustrating a configuration of a drive circuit.

FIG. 5 is a plan view of a signal convertor.

FIG. 6 is a cross-sectional view taken along line a in FIG. 5.

FIG. 7 is an explanatory diagram of a magnetic field generated in the detector circuit.

FIG. 8 is a circuit diagram illustrating a specific configuration of a resonance circuit in the detectable circuit.

FIG. 9 is a plan view of the detectable circuit.

FIG. 10 is a cross-sectional view of line b-b in FIG. 9.

FIG. 11A is an explanatory diagram of a deviation amount Δr between a central axis C1 of a coil La and a central axis C2 of a coil Lb, when viewed in plan view from the normal direction of the coil La.

FIG. 11B is a graph showing characteristics N0, N1, and N2 showing a relation between a distance D and a voltage E.

FIG. 12 is a graph showing a normalization characteristic N.

FIG. 13 is a functional block diagram showing functions of the control device 31.

FIG. 14 is a graph showing a relation between the voltage E and a normalized voltage En.

FIG. 15 is a flowchart showing an operation of the control device 31 in a calibration mode.

FIG. 16 is a flowchart showing an operation of the control device 31 in a playing mode.

FIG. 17 is a graph showing a relation between the deviation amount Δr and a voltage E in a case in which the distance D between the coil La and the coil Lb is 1 mm.

FIG. 18 is a schematic diagram showing a configuration in which a detection system 20 is adopted for a strike mechanism 2A of the keyboard musical instrument 100.

FIG. 19 is a schematic diagram showing a configuration in which the detection system 20 is adopted for a pedal mechanism 3A of the keyboard musical instrument 100.

FIG. 20 is a schematic diagram showing a configuration in which the detection system 20 is adopted for a keyboard mechanism 4A of the keyboard musical instrument 100.

### DETAILED DESCRIPTION OF THE EMBODIMENTS

### A: First Embodiment

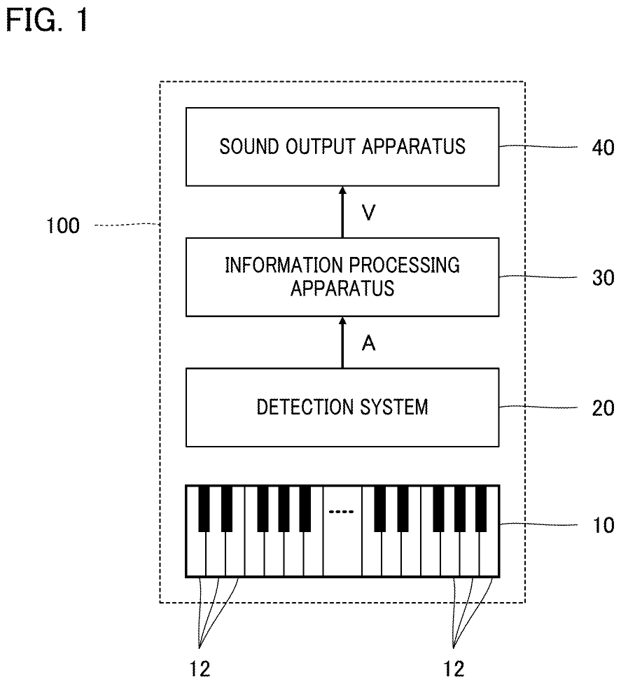

FIG. 1 is a block diagram illustrating a configuration of a keyboard musical instrument 100 according to a first embodiment of the present disclosure. The keyboard musical instrument 100 includes a keyboard 10, a detection system 20, an information processing apparatus 30, and a sound output apparatus 40. The keyboard musical instrument 100 is an example of a musical instrument. The keyboard 10 includes K keys 12 including white keys and black keys, where K is an integer of 2 or more. For example, K is “88.”

Each of the K keys 12 is displaceable within a movable range, and each of the K keys 12 is an example of a movable member that is displaceable in accordance with a playing operation of a user. The detection system 20 detects a position of a key 12 operated by the user. The information processing apparatus 30 generates an audio signal V in accordance with a detection result of the detection system 20. The audio signal V represents a music sound with a pitch corresponding to the key 12 operated by the user. The sound output apparatus 40 outputs sound represented by the audio signal V. For example, a speaker or headphones is used as the sound output apparatus 40.

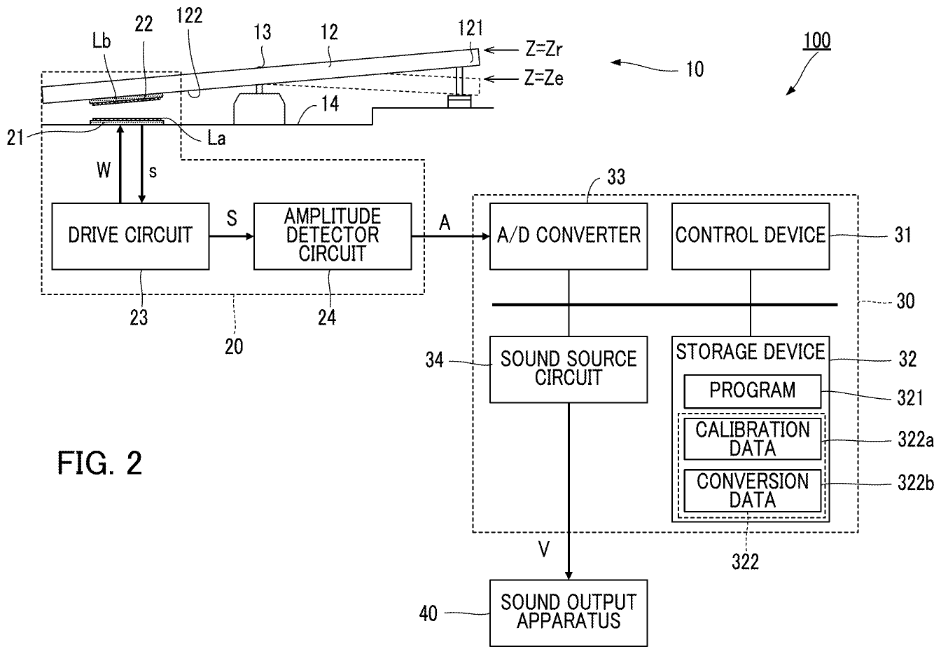

FIG. 2 is a block diagram illustrating a specific configuration of the keyboard musical instrument 100, with a focus on a key 12 of the keyboard 10. Each key 12 of the keyboard 10 is supported by a support member 14 with a fulcrum portion (balance pin) 13 acting as a pivot point. The support member 14 is a structure (frame) that supports each element of the keyboard musical instrument 100. The support member 14 is an example of a fixed member that is not displaceable in accordance with a playing operation. An end portion 121 of the key 12 is displaced in the vertical direction by depression and release of the key by a user. In the following description, the position of the end portion 121 of the key 12 is referred to as a position Z of the key 12. Hereafter, a first state is a state where a force caused by a playing operation or a static load for calibration does not act on the key 12. Also, hereafter, a second state is a state where a force caused by a playing operation acts on the key 12. The position Z of the key 12 in the first state is referred to as a rest position Zr. In the second state, the position Z of the key 12 in a state in which the key 12 is pressed downmost is referred to as an end position Ze. The movable range of the key 12 is a range from the rest position Zr to the end position Ze. The first state is a state in which the key 12 is in the initial position and is not displaced. The second state is a state in which the key 12 is displaced.

The detection system 20 generates, for each of the K keys 12, an amplitude signal A with a level corresponding to a position Z in the vertical direction. The position Z shows a displacement amount of the end portion 121 with respect to the position of the end portion 121 in the first state (rest position Zr) in which no load acts on the key 12.

The detection system 20 includes K detector circuits 21, K detectable circuits 22, a drive circuit 23, and an amplitude detector circuit 24. The K detector circuits 21 have a one-to-one correspondence with the K keys 12, and the K detectable circuits 22 have a one-to-one correspondence with the K keys 12. That is, for each of the keys 12 a detector circuit 21 and a detectable circuit 22 is disposed. Each detector circuit 21 is disposed on the support member 14, and each detectable circuit 22 corresponding to each key 12 is disposed on the key 12. Specifically, the detectable circuit 22 is disposed on the bottom surface (hereafter, “installation surface”) 122 of the key 12. The drive circuit 23 and the amplitude detector circuit 24 are shared by the K keys 12.

The detector circuit 21 includes a coil La. The detectable circuit 22 includes a coil Lb. The coil La and the coil Lb are vertically spaced apart from each other. The distance between the detector circuit 21 and the detectable circuit 22 (the distance between the coil La and the coil Lb) varies depending on the position Z. The amplitude detector circuit 24 generates an amplitude signal A corresponding to a distance between the coil La and the coil Lb.

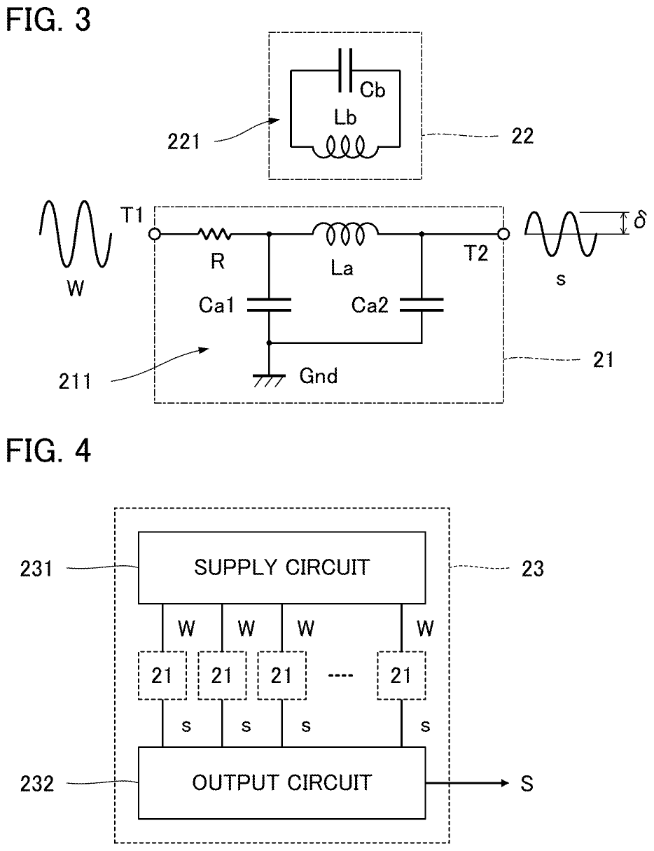

FIG. 3 is a circuit diagram illustrating an electrical configuration of the detector circuit 21 and the detectable circuit 22 corresponding to the key 12. The detector circuit 21 includes a resonance circuit 211. The resonance circuit 211 includes an input terminal Ti, an output terminal T2, a resistive element R, a coil La, a capacitive element Ca1, and a capacitive element Ca2. One end of the resistive element R is connected to the input terminal Ti, and the other end of the resistive element R is connected to one end of the capacitive element Ca1 and one end of the coil La. The other end of the coil La is connected to the output terminal T2 and one end of the capacitive element Ca2. The other end of the capacitive element Ca1 and the other end of the capacitive element Ca2 are grounded (Gnd).

The detectable circuit 22 includes a resonance circuit 221. The resonance circuit 221 includes a coil Lb and a capacitive element Cb. Specifically, one end of the coil Lb and one end of the capacitive element Cb are connected to each other, and the other end of the coil Lb and the other end of the capacitive element Cb are connected to each other. The resonance frequency of the resonance circuit 211 and the resonance frequency of the resonance circuit 221 are set to the same frequency. However, the resonance frequency of the resonance circuit 211 may be different from the resonance frequency of the resonance circuit 221. For example, the resonance frequency of the resonance circuit 211 may be set to a frequency obtained by multiplying the resonance frequency of the resonance circuit 221 by a predetermined constant.

FIG. 4 is a block diagram illustrating a specific configuration of the drive circuit 23. The drive circuit 23 includes a supply circuit 231 and an output circuit 232. The supply circuit 231 supplies a reference signal W to the input terminal Ti of each of the K detector circuits 21. For example, the supply circuit 231 is a demultiplexer that supplies the reference signal W to each of the K detector circuits 21 in time division. The reference signal W is a voltage signal, and the level of the signal varies periodically. For example, a periodic signal of a freely selected waveform, such as a sine wave, a square wave, and a sawtooth wave, is used as the reference signal W. One cycle of the reference signal W is sufficiently shorter than the time length of a period during which the reference signal W is supplied to one detector circuit 21. Further, the frequency of the reference signal W is set to a frequency substantially equal to the resonance frequency of the resonance circuit 211 and the resonance circuit 221.

The reference signal W is supplied to the coil La through the input terminal T1 and the resistive element R. In response to the supply of the reference signal W, a magnetic field is generated in the coil La. An electromagnetic induction due to the magnetic field generated in the coil La causes an induced current to be generated in the coil Lb of the detectable circuit 22. That is, a magnetic field that cancels a change in the magnetic field of the coil Lb is generated in the coil La. In the following explanation, the distance between the coil La and the coil Lb is referred to as a distance D. The magnetic field generated in the coil La varies depending on the distance D. Therefore, the amplitude δ of a detection signal s varies depending on the distance D. The detector circuit 21 outputs, via the output terminal T2, a detection signal s having an amplitude δ corresponding to the distance D. The amplitude δ of the detection signal s increases as the distance D increases, and decreases as the distance D decreases. This is because, the shorter the distance D, the greater the current that flows in the coil La, thereby cancelling the magnetic field generated in the coil Lb. In the present embodiment, in a case in which the key 12 is in the rest position Zr, the coil La and the coil Lb are closest to each other, and the distance D therebetween is the smallest. Therefore, when the key 12 is in the rest position Zr, the amplitude δ of the detected signal s is smallest. In other words, the detector circuit 21 and the detectable circuit 22 are disposed such that the amplitude δ of the detection signal s is smallest in the first state.

For the reasons described below, the detector circuit 21 and the detectable circuit 22 are disposed such that the distance D is the smallest in the rest position Zr. The first reason is to minimize unwanted radiation noise of the amplitude δ of the detection signal s. The keyboard musical instrument 100 of this example has 88 keys 12. During playing, 10 keys 12 may be pressed, for example, and thus 78 keys 12 are not pressed and remain in the first state. Therefore, compared with a case in which the distance D is the smallest in the end position Ze, it is possible to reduce unwanted radiation noise from the keyboard musical instrument 100 in a case in which the distance D is the smallest in the rest position Zr.

The second reason is that calibration described later can be performed in the first state in which the key 12 is in the rest position Zr. The amplitude δ of the detection signal s varies due to, for example, a deviation in the mounting position between the coil La and the coil Lb. As will be described later, in the present embodiment, calibration is performed to absorb a variation in the amplitude δ. The calibration is preferably carried out under a minimum distance D. In a case in which the distance D is the smallest in the rest position Zr, an advantage is obtained in that the calibration can be performed immediately after the keyboard musical instrument 100 is powered on.

The output circuit 232 of FIG. 4 is a multiplexer that generates a detection signal S by aligning along a time axis detection signals s that are sequentially output from each of the plurality of detector circuits 21. The output circuit 232 generates a detection signal S by time-division multiplexing the K detection signals s. That is, the detection signal S is a voltage signal having amplitudes δ corresponding to a distance between the coil La and the coil Lb of each of the keys 12. As described above, since the distance between the coil La and the coil Lb is correlated with the position Z of the key 12, the detection signal S is expressed as a signal corresponding to the positions Z of the K keys 12.

The amplitude detector circuit 24 generates an amplitude signal A by smoothing the detection signal S after rectifying it. The rectification may be either half-wave rectification or full-wave rectification. The amplitude signal A has voltages E corresponding to the amplitudes δ of the detection signal S. Therefore, the amplitude signal A is a signal obtained by time-division multiplexing signals each indicating the voltage E corresponding to the amplitude δ of each detection signal s. The amplitude detector circuit 24 outputs the amplitude signal A to the information processing apparatus 30. The detection system 20 may output the detection signal S to the information processing apparatus 30. In this case, the information processing apparatus 30 may detect the amplitude δ of each detection signal s based on the detection signal S.

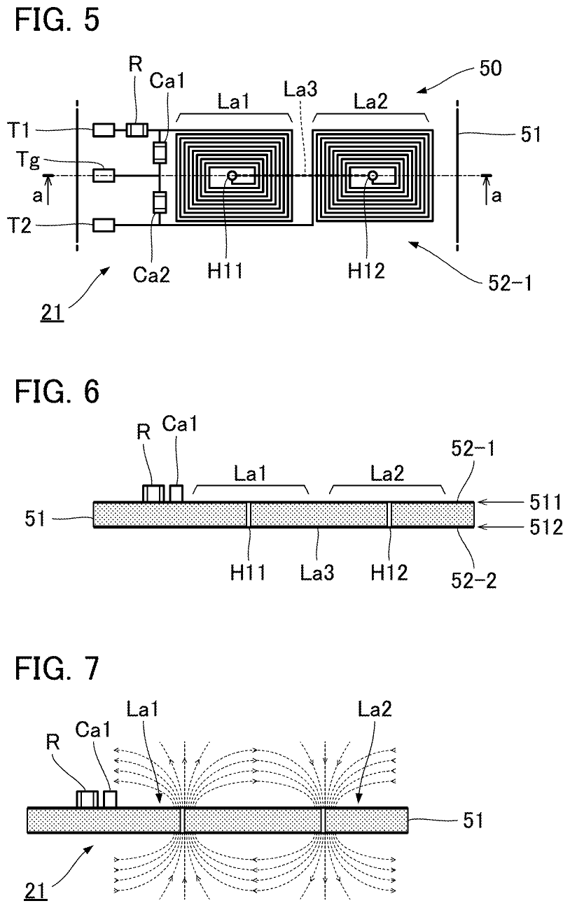

FIG. 5 is a plan view illustrating a detailed configuration of the detector circuit 21 corresponding to one key 12. A plan view of the detector circuit 21 viewed from the detectable circuit 22 (upward in the vertical direction) is shown in FIG. 5. FIG. 6 is a cross-sectional view taken along line a in FIG. 5. The longitudinal direction in FIG. 5 corresponds to a direction in which the K keys 12 are aligned. The lateral direction in FIG. 5 corresponds to the longitudinal direction of the key 12. The detector circuit 21 is a circuit board 50 that includes a board 51 on which the resonance circuit 211 is disposed. The board 51 is an insulating, plate-shaped member having a surface 511 and a surface 512. The surface 511 is on the opposite side of the board 51 to the surface 512. The surface 511 is a top surface of the board 51 that faces the detectable circuit 22. The surface 512 is a bottom surface of the board 51 that faces the support member 14.

On the board 51, there are formed a wiring pattern 52-1 and a wiring pattern 52-2 that constitute the resonance circuit 211. The wiring pattern 52-1 is formed on the surface 511, and the wiring pattern 52-2 is formed on the surface 512. Each of the wiring pattern 52-1 and the wiring pattern 52-2 is a conductive film formed in a predetermined planar shape. Specifically, the wiring pattern 52-1 is formed by patterning the conductive film covering the entire surface 511. Similar1y, the wiring pattern 52-2 is formed by patterning the conductive film covering the entire surface 512.

The wiring pattern 52-1 includes a first coil portion La1, a second coil portion La2, an input terminal T1, an output terminal T2, and a grounding terminal Tg. As described with reference to FIG. 3, the reference signal W is supplied to the input terminal T1, and the amplitude signal A is output from the output terminal T2. The grounding terminal Tg is grounded.

Each of the first coil portion La1 and the second coil portion La2 is formed in a rectangular spiral shape. The winding direction of the first coil portion La1 is the same as the winding direction of the second coil portion La2. For example, the first coil portion La1 and the second coil portion La2 are wound counterclockwise from the center to the outward. The first coil portion La1 and the second coil portion La2 are adjacent to each other. Specifically, the first coil portion La1 and the second coil portion La2 are aligned along a direction perpendicular to the direction (lateral direction) in which the K keys 12 are aligned.

The wiring pattern 52-2 includes a connecting portion La3. The center of the first coil portion La1 is electrically connected to one end of the connecting portion La3 via the conductive hole H11. The center of the second coil portion La2 is electrically connected to the other end of the connecting portion La3 via the conductive hole H12. Each of the conductive hole H11 and the conductive hole H12 is a through hole that penetrates the board 51. As described above, the first coil portion La1 and the second coil portion La2 are electrically connected to each other via the connecting portion La3. The first coil portion La1, the second coil portion La2, and the connecting portion La3 constitute the coil La of FIG. 3.

A resistive element R, a capacitive element Ca1, and a capacitive element Ca2 are mounted on the surface 511 of the board 51. The resistive element R is mounted on the board 51 as an electronic component (chip resistor). Similarly, the capacitive element Ca1 and the capacitive element Ca2 are mounted on the board 51 as electronic components (chip capacitors).

A magnetic field is generated in each of the first coil portion La1 and the second coil portion La2 in response to a supply of a current. As will be understood from FIG. 5, the direction of the current flowing in the first coil portion La1 and the direction of the current flowing in the second coil portion La2 are in opposite directions. Therefore, as illustrated in FIG. 7, the first coil portion La1 and the second coil portion La2 generate magnetic fields in opposite directions. That is, when a magnetic field in the first direction is generated in the first coil portion La1, a magnetic field in a second direction opposite to the first direction is generated in the second coil portion La2. According to the above configuration, since a magnetic field from one of the first coil portion La1 and the second coil portion La2 toward the other is formed, the spread of the magnetic field between the keys 12 adjacent to each other is reduced. That is, interference of the magnetic field between two adjacent coils Lb is reduced. Therefore, it is possible to generate a detection signal s that reflects the position Z of each of the K keys 12 with high accuracy.

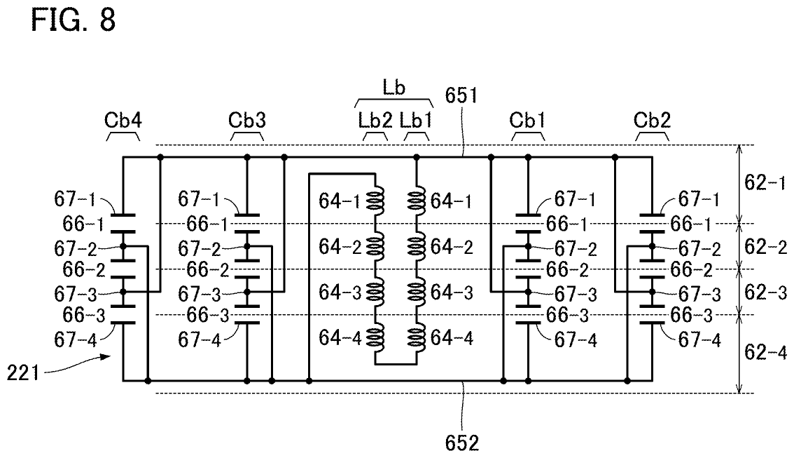

FIG. 8 is a circuit diagram illustrating a specific configuration of the resonance circuit 221 in the detectable circuit 22. The coil Lb illustrated in FIG. 3 is constituted of a first coil portion Lb1 and a second coil portion Lb2. The first coil portion Lb1 and the second coil portion Lb2 are connected in series between a wiring 651 and a wiring 652. Each of the first coil portion Lb1 and the second coil portion Lb2 includes four portions 64-1 to 64-4 connected to each other in series.

The capacitive element Cb illustrated in FIG. 3 is constituted of four capacitive elements Cb1 to Cb4. The four capacitive elements Cb1 to Cb4 are connected in parallel between the wiring 651 and the wiring 652. Each of the four capacitive elements Cb1 to Cb4 includes three capacitive portions 66-1 to 66-3 connected in parallel. The capacitive portion 66-1 includes an electrode 67-1 and an electrode 67-2. The capacitive portion 66-2 includes an electrode 67-2 and an electrode 67-3. The capacitive element 66-3 includes an electrode 67-3 and an electrode 67-4.

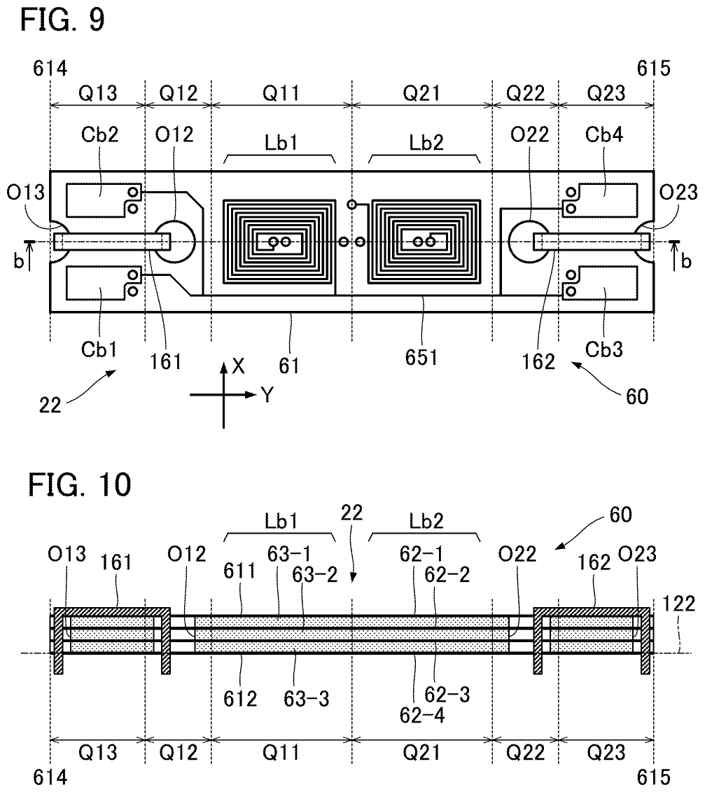

FIG. 9 is a plan view illustrating a detailed configuration of the detectable circuit 22. A plan view of the detectable circuit 22 viewed from the detector circuit 21 (downward in the vertical direction) is shown in FIG. 9. FIG. 10 is a cross-sectional view taken along line b-b in FIG. 9. In the following description, it is assumed that the X axis and the Y axis are orthogonal to each other. The X-Y plane is parallel to the installation surface 122 of the key 12. The K keys 12 are aligned along the X-axis, and each key 12 is elongate along the Y-axis. A view from a direction orthogonal to the X-Y plane is hereinafter referred to as a “plan view.”

The detectable circuit 22 is a circuit board 60 including a board 61 on which the resonance circuit 221 is disposed. The board 61 is an insulating, plate-shaped member having a surface 611 and a surface 612. The surface 611 is on the opposite side of the board 61 to the surface 612. Specifically, the surface 611 of the board 61 faces the detector circuit 21, and the surface 612 of the board 61 faces the installation surface 122 of the key 12. The board 61 of the first embodiment is formed in a rectangular shape elongate in the Y-axis direction.

The board 61 includes a plurality of regions (Q11,Q12,Q13,Q21,Q22,Q23) along the Y-axis. The region Q11 and the region Q21 are near the center of the board 61 in the direction of the Y axis. The region Q11 is in the negative Y-axis direction relative to the midpoint of the board 61 in the Y-axis direction, and the region Q21 is in the positive Y-axis direction relative to the midpoint. The region Q13 of the board 61 includes an end portion 614 located in the negative Y-axis direction. The region Q12 is between the region Q11 and the region Q13. The region Q23 of the board 61 is a region that includes an end portion 615 located in the positive Y-axis direction, and the region Q22 is a region between the region Q21 and the region Q23.

The first coil portion Lb1 is formed in the region Q11. The capacitive element Cb1 and the capacitive element Cb2 are formed in the region Q13. The capacitive element Cb1 and the capacitive element Cb2 are aligned in the region Q13, spaced apart from each other in the X-direction in plan view. As will be understood from the above explanation, as shown in plan view the capacitive element Cb1 and the capacitive element Cb2 are formed between the first coil portion Lb1 and the end portion 614 of the board 61. That is, the capacitive element Cb1 and the capacitive element Cb2 are formed at locations spaced apart from the first coil portion Lb1 in the negative Y-axis direction by a distance corresponding to the region Q12.

In a configuration in which the capacitive element Cb1 and the capacitive element Cb2 are close to the first coil portion Lb1, a magnetic field generated in the first coil portion Lb1 is influenced by the capacitive element Cb1 or the capacitive element Cb2. However, according to the configuration of the first embodiment in which the region Q12 is formed between (i) the capacitive element Cb1 and the capacitive element Cb2 and (ii) the first coil portion Lb1, sufficient distance can be secured between (i) the capacitive element Cb1 and the capacitive element Cb2 and (ii) the first coil portion Lb1. Therefore, it is possible to reduce an influence of the capacitive element Cb1 and the capacitive element Cb2 on a magnetic field generated in the first coil portion Lb1.

The second coil portion Lb2 is formed in the region Q21. The capacitive element Cb3 and the capacitive element Cb4 are formed in the region Q23. The capacitive element Cb3 and the capacitive element Cb4 are aligned in the region Q23, spaced apart from each other in the X-direction in plan view. As will be understood from the above explanation, the capacitive element Cb3 and the capacitive element Cb4 are formed at locations spaced apart from the second coil portion Lb2 in the positive Y-axis direction by a distance corresponding to the region Q22. Therefore, sufficient distance can be secured between (i) the capacitive element Cb3 and the capacitive element Cb4 and (ii) the second coil portion Lb2.

As will be understood from the above examples, in plan view, the coil Lb (the first coil portion Lb1 and the second coil portion Lb2) is located between (i) the pair of the capacitive element Cb1 and the capacitive element Cb2 and (ii) the pair of the capacitive element Cb3 and the capacitive element Cb4. The above described configuration has an advantage in that capacitance of the capacitive element Cb can be easily secured while reducing an influence of the capacitive element Cb (Cb1 to Cb4) on a magnetic field generated in the coil Lb, compared with a configuration in which the capacitive element Cb is formed between the first coil portion Lb1 and the second coil portion Lb2, for example.

Reference is now again made to FIG. 2. The information processing apparatus 30 generates position data indicating the position Z of the key 12 by analyzing the amplitude signal A supplied from the amplitude detector circuit 24. The information processing apparatus 30 is realized by a computer system including a control device 31, a storage device 32, an A/D converter 33, and a sound source circuit 34. It is of note that the information processing apparatus 30 is realized by a single apparatus, but may also be realized by multiple apparatuses configured separately from each other. The control device 31 includes one or more processors that control each element of the keyboard musical instrument 100. Specifically, the control device 31 is configured by one or more types of processors such as a Central Processing Unit (CPU), a Sound Processing Unit (SPU), a Digital Signal Processor (DSP), a Field Programmable Gate Array (FPGA), or an Application Specific Integrated Circuit (ASIC).

The storage device 32 comprises one or a plurality of memories that store a program 321 executed by the control device 31 and correspondence data 322. The correspondence data 322 indicates correspondences between (i) the voltage E depending on the amplitude δ of the detection signal s and (ii) the position Z. The correspondence data 322 includes calibration data 322a and conversion data 322b. The calibration data 322a is used to generate a normalized voltage En, which will be described later, from the voltage E corresponding to the amplitude δ of the detected signal s. The conversion data 322b indicates correspondences between the normalized voltage En and the position Z. The storage device 32 serves as a work area for the control device 31. The storage device 32 comprises a known recording medium, such as a magnetic recording medium or a semiconductor recording medium. It is of note that the storage device 32 may be configured by a combination of a plurality of types of recording media. A portable recording medium detachable from the keyboard musical instrument 100 or an external recording medium (for example, online storage) with which the keyboard musical instrument 100 is communicable may be used as the storage device 32.

The A/D converter 33 converts the amplitude signal A supplied from the drive circuit 23 from analog to digital. The control device 31 generates position data indicating the position Z each of the K keys 12 by analyzing the amplitude signal A, which has been converted by the A/D converter 33. Further, the control device 31 instructs the sound source circuit 34 to produce a music sound in accordance with a position Z of each key 12. The sound source circuit 34 generates an audio signal V representing the music sound instructed by the control device 31. Specifically, an audio signal V is generated representing a music sound of a pitch corresponding to a key 12 for which the position Z has changed among the plurality of pitches. The volume of the audio signal V is controlled in accordance with, for example, a velocity at which the position Z changes. In response to a supply of the audio signal V from the sound source circuit 34 to the sound output apparatus 40, a music sound corresponding to a playing operation (depression or release of each key 12) by the user is emitted from the sound output apparatus 40. It is of note that the control device 31 may realize the function of the sound source circuit 34 by executing the program 321 stored in the storage device 32.

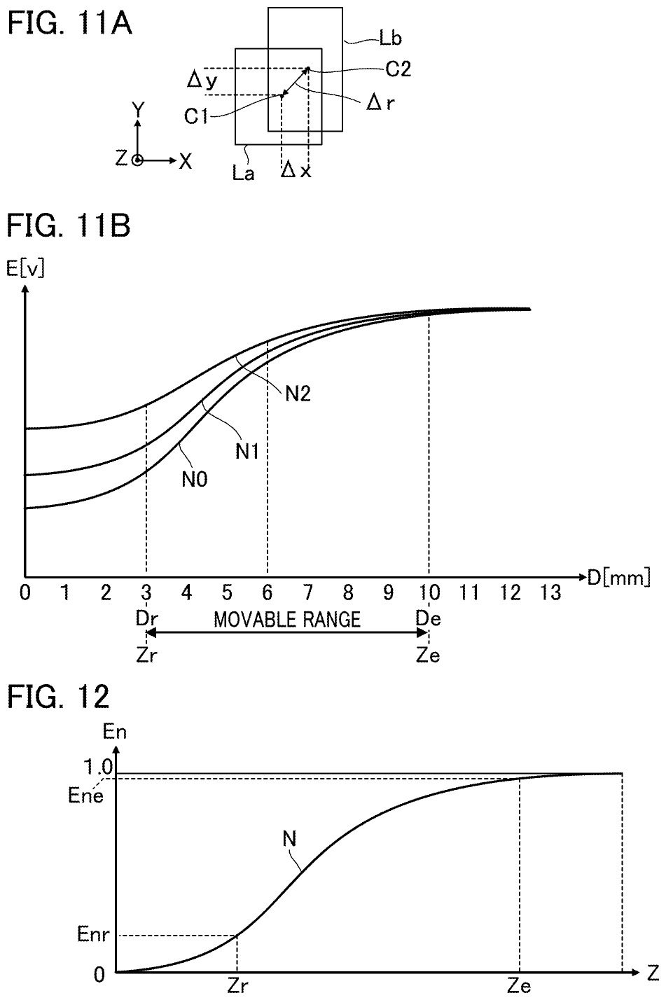

Description will now be given of the relationship between (i) the voltage E of the amplitude signal A and (ii) the distance D between the coil La to the coil Lb. FIG. 11A is an explanatory diagram explaining a deviation (misalignment) amount Δr between a central axis C1 of the coil La and a central axis C2 of the coil Lb in plan view. The deviation amount Δr shown in FIG. 11A can be expressed as Δr=(Δx²+Δy²)^{1/2}, where Δx is a distance along the X-axis between the central axis C1 and the central axis C2, and Δy is a distance along the Y-axis between the central axis C1 and the central axis C2.

FIG. 11B is a graph showing characteristics N0, N1, and N2 that each represent a relation between the distance D and the voltage E. The characteristic NO is a curve indicating a relation between the distance D and the voltage E in a case in which the deviation amount Δr is zero, i.e., in a case in which the central axis C1 of the coil La and the central axis C2 of the coil Lb coincide with each other in plan view. The characteristic N1 is a curve indicating a relation between the distance D and the voltage E in a case in which the deviation amount Δr is equal to r1. The characteristic N2 is a curve indicating a relation between the distance D and the voltage E in a case in which the deviation amount Δr is equal to r2, where r2>r1.

Thus, the smaller the deviation amount Δr is, the smaller the voltage E is when the distance D is zero. This is because, the smaller the deviation amount Δr is, the greater is the degree to which the magnetic field of the coil Lb acts on the magnetic field of the coil La. On the other hand, when the distance D is equal to or greater than 10 mm, the voltage E is hardly affected by the distance between the central axis C1 and the central axis C2 of the coil Lb. This is because, in a case in which the distance D is greater than or equal to 10 mm, the magnetic field of the coil Lb hardly acts on the magnetic field of the coil La.

As described above, the detector circuit 21 with the coil La is disposed on the support member 14, and the detectable circuit 22 with the coil Lb is disposed on the installation surface 122 of the key 12. The movable range of the key 12 is the range from the rest position Zr to the end position Ze. In this embodiment, when the key 12 is in the rest position Zr, the coil La and the coil Lb are closest to each other. The distance Dr in this case is 3 mm. On the other hand, when the key 12 is in the end position Ze, the coil La and the coil Lb are farthest from each other. The distance De in this case is 10 mm.

The mounting position of the detector circuit 21 disposed on the support member 14 and the mounting position of the detectable circuit 22 disposed on the key 12 vary. Accordingly, the relation between the distance D and the voltage E varies for different keys 12, such as in characteristics N0, N1, and N2. Furthermore, the resistance value of the resistive element R, the inductance value of the coil La, the capacitance value of the capacitive element Ca1, and the capacitance value of the capacitive element Ca2, which constitute the detector circuit 21, vary. Also, the relation between the distance D and the voltage E varies for different keys 12 due to variations in the values of these elements, and also due to temperature characteristics and aging of these elements.

In the present embodiment, to absorb various variations, the plurality of characteristics shown in FIG. 11B are normalized to the normalization characteristic N shown in FIG. 12, and the distance D is obtained from the voltage E using the normalization characteristic N. The normalization characteristic N indicates a relation between the normalized voltage En obtained by normalizing the voltage E and the distance D. The normalized voltage En is obtained by Equation (1).

En=(E−E0)/(Ei−E0) (1),
where E0 is a voltage value of the voltage E in a state in which the distance D is zero. That is, E0 is a voltage value of the voltage E in a state in which the detector circuit 21 is in contact with the detectable circuit 22. Ei is a voltage value of the voltage E in a state in which the distance D is infinite. In other words, Ei is a value of the voltage E in the absence of the detectable circuit 22. The normalized voltage En varies within a range from 0 to 1.

In a state that the K keys 12 have not yet been assembled in the keyboard musical instrument 100 after the K detector circuits 21 are disposed on the support member 14, no detectable circuit 22 is paired with the detector circuit 21. Thus, in this state, the voltage value Ei is measurable. In contrast, the voltage value E0 is not measurable because there is no detectable circuit 22 paired with the detector circuit 21. Therefore, the voltage value E0 needs to be measured with the K keys 12 assembled in the keyboard musical instrument 100 and with a detectable circuit 22 mounted to a key. However, since the key 12 cannot be displaced beyond the rest position Zr, the voltage value E0 is not measurable. Accordingly, in the present embodiment, the voltage value E0 is estimated based on a rest voltage value Er of the voltage E at the rest position Zr, and the normalized voltage En is calculated using the estimated voltage value E0.

The position Z of the key 12 corresponding to the voltage value E0 is the position Z of the key 12 at which the distance D is zero. The position Z of the key 12 at which the distance D is zero is an example of a reference position. The position Z of the key 12 at which the distance D is zero is an example of a position Z closer to the coil La than the rest position Zr at which the distance D is the smallest within the movable range. The rest position Zr is an example of a predetermined position within the movable range of the key 12, which is a movable member. The rest position Zr is the position Z of the key 12 at which the distance D is smallest within the movable range of the key 12.

The normalization characteristic N indicates a relation of the normalized voltage En to the distance D. In the keyboard musical instrument 100, the normalized voltage En is calculated by normalizing the voltage E, and the distance D is specified based on the calculated normalized voltage En. Therefore, the inverse function of the normalization characteristic N is calculated in advance. The function indicating the normalization characteristic N is given by the Equation (2) indicated below. The inverse function is given by Equation (3).

En=F(D) (2)

D=F⁻¹(En) (3)

The conversion data 322b stored in the storage device 32 is an inverse function represented by Equation (3). Thus, by referring to the conversion data 322b, the distance D corresponding to the normalized voltage En is obtained.

The operation mode of the keyboard musical instrument 100 is generally divided into a calibration mode and a playing mode. A setter 310 (described later) switches the operation mode of the keyboard musical instrument 100 between the playing mode and the calibration mode. The control device 31 generates calibration data 322a by executing a calibration process or the like in the calibration mode. In the playing mode, the control device 31 detects an amplitude signal A dependent on a playing operation of the user, and generates an audio signal V based on the detected amplitude signal A.

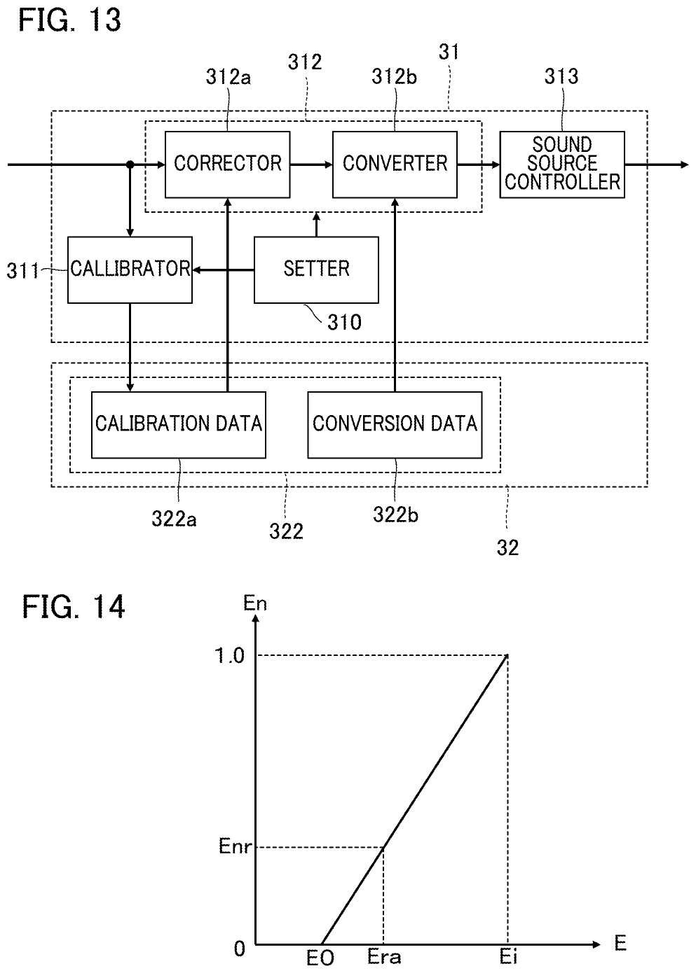

FIG. 13 is a functional block diagram illustrating functions of the control device 31. The control device 31 reads the program 321 from the storage device 32 and executes the read program, thereby functioning as the setter 310, a calibrator 311, a generator 312, and a sound source controller 313.

The setter 310 sets the operation mode of the keyboard musical instrument 100 to the calibration mode or the playing mode. When a predetermined condition is satisfied, the setter 310 causes the operation mode of the keyboard musical instrument 100 to transition from the calibration mode to the playing mode, or transition from the playing mode to the calibration mode. For example, in response to turning-on of the keyboard musical instrument 100, the setter 310 selects the calibration mode, and when a series of calibration processes ends, the operation mode transitions from the calibration mode to the playing mode. The setter 310 may cause the operation mode to transition from the playing mode to the calibration mode in response to a detection of simultaneous pressing of multiple predetermined keys 12 of the K keys 12 in the playing mode. For example, simultaneous pressing of a key 12 at the left end and a key 12 at the right end of the K keys 12 may constitute a condition for transition from the playing mode to the calibration mode.

The calibrator 311 operates in the calibration mode. The calibrator 311 generates calibration data 322a by analyzing an amplitude signal A, and stores the generated calibration data 322a in the storage device 32. The generator 312 operates in the playing mode. The generator 312 generates position data indicating the position Z of a key 12 based on the voltage E. The generator 312 includes a corrector 312a and a converter 312b. The corrector 312a generates a normalized voltage En by correcting the voltage E, using the calibration data 322a. The converter 312b operates in the playing mode. The converter 312b converts the normalized voltage En into a distance D by referring to the conversion data 322b. The generator 312 generates position data based on the distance D. The sound source controller 313 generates playing data for controlling the sound source circuit 34 based on the position data.

As described above, in the amplitude signal A, the K voltages E corresponding one-to-one with the K detector circuits 21 have been multiplexed in time division. In a case in which a key 12 is in the first state, the position Z of the key 12 is the rest position Zr. The voltage E when the key 12 is in the rest position Zr is referred to as a rest voltage value Er. In the first state, in which the key 12 is at the rest position Zr, the calibrator 311 calculates, based on the amplitude signal A, an average rest voltage value Era that is an average value of the K rest voltage values Er. The average rest voltage value Era is given by Equation (4) below.

Era=(Er1+Er2+ . . . +ErK)/K (4),
where Er1, Er2, . . . ErK are the rest voltage values Er corresponding one-to-one with the K keys 12.

The calibrator 311 estimates the voltage value E0 based on the average rest voltage value Era. FIG. 14 shows a relation between the voltage E and the normalized voltage En. A voltage value Enr is a value of the normalized voltage En when a key 12 is in the rest position Zr. The voltage value Enr is known. The voltage value Ei is also known. Therefore, E0 can be calculated by substituting the average rest voltage value Era in Equation (1). Equation (5) is obtained when the average rest voltage value Era and the voltage value Enr are substituted into Equation (1).

Enr=(Era−E0)/(Ei−E0) (5)

Equation (6) is derived by modifying Equation (5).

E0=(Era−Enr*Ei)/(1−Enr) (6)

The calibrator 311 estimates the voltage value E0, using Equation (6).

The average rest voltage value Era is used for estimation of the voltage value E0 for the following reasons. The first reason is that the rest voltage value Er can be measured when a key 12 is in the rest position Zr. In the present embodiment, the key 12 is in the rest position Zr in the first state in which no force caused by the playing operation acts on the key 12. Therefore, the voltage value E0 can be estimated in a period from a time point at which the keyboard musical instrument 100 is powered on to a time point at which a predetermined time elapses. In a period immediately after the power is turned on, it is highly likely that the user has not yet started playing, and thus it is possible to execute the calibration without the user being aware of the calibration mode.

The second reason is that since the rest position Zr is the position of the key 12 in the first state, the rest position Zr is less likely to vary, compared with other positions within the movable range.

The third reason is that the distance Dr in the rest position Zr is 3 mm on average, and that the voltage of the normalized voltage En for the distance Dr is Enr. The actual voltage value Enr varies for the key 12. However, in a state that the K keys 12 are assembled in the keyboard musical instrument 100, although it is not possible to measure the distance Dr for each key 12, it is known that the average distance Dr is 3 mm Therefore, there is little need to estimate the voltage value E0 for each key 12. Since the voltage value E0 does not have to be estimated for each rest voltage value Er, the processing load of the control device 31 can be reduced.

The calibrator 311 generates calibration data 322a using the estimated voltage value E0. The calibration data 322a represents a relation between the voltage E and the normalized voltage En. The voltage E and the normalized voltage En have a linear relationship as shown in FIG. 14. The voltage E and the normalized voltage En have the relation expressed by Equation (7) shown below.

En=p*E+q (7),
where p and q are constants. The constant p is expressed by Equation (8), and the constant q is expressed by Equation (9).

p=1/(Ei−E0) (8)

q=−E0/(Ei−E0) (9)

Based on the estimated voltage value E0 and the voltage value Ei measured in advance, the calibrator 311 generates a pair of constants p and q as the calibration data 322a. The calibrator 311 may generate a pair of constants p and q for each detector circuit 21, or may generate a pair of constants p and q common to the K detector circuits 21. In generating a pair of constants p and q for each detector circuit 21, the calibrator 311 generates the pair of constants p and q for each detector circuit 21 based on the voltage value Ei measured for each detector circuit 21 and the voltage value E0 common to the K detector circuits 21. On the other hand, in generating a pair of constants p and q common to the K detector circuits 21, the calibrator 311 generates the pair of constants p and q based on the average voltage of voltage values Ei measured for the respective detector circuits 21 and the voltage value E0 common to the K detector circuits 21.

The corrector 312a generates a normalized voltage En by correcting the voltage E, using the calibration data 322a. The converter 312b generates a distance D based on the normalized voltage En by using the conversion data 322b. The generator 312 generates position data indicating the position of the key 12 based on the generated distance D.

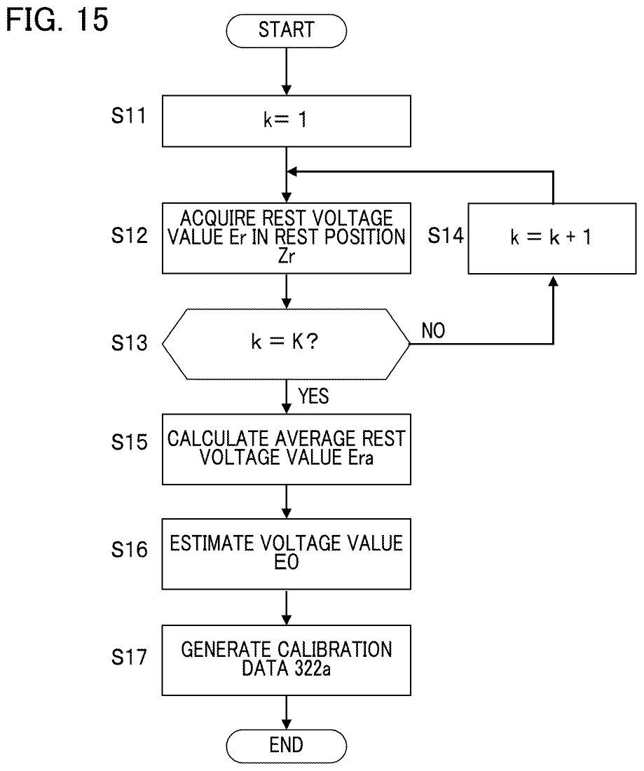

Next, an operation of the control device 31 in the calibration mode and an operation of the control device 31 in the playing mode will be described separately. FIG. 15 is a flowchart showing the operation of the control device 31 in the calibration mode. The operation of FIG. 15 is performed in a period from a time at which the keyboard musical instrument 100 is powered on to a time at which a predetermined time elapses. The predetermined time is preferably 0.1 seconds or more and 3 minutes or less. The control device 31 functions as the calibrator 311 in the calibration mode.

First, the control device 31 sets a variable k to “1” (S11). Next, the control device 31 acquires a rest voltage value Er in the rest position Zr of a key 12 (S12). As described above, the key 12 is in the rest position Zr in the first state. Therefore, no particular operation is required to place the key 12 in the rest position Zr. The control device 31 acquires the voltage E of an amplitude signal A corresponding to the kth key 12 as the rest voltage value Er.

Next, the control device 31 determines whether the variable k matches “K” (S13). In a case in which a result of the determination is negative, the control device 31 increments the variable k by “1” (S14), and returns the process to step S12. In a case in which the determination result of step S13 is affirmative, the control device 31 calculates an average rest voltage value Era in accordance with Equation (4) described above (S15).

Next, the control device 31 estimates a voltage value E0 based on the average rest voltage value Era, a voltage value Ei, and a voltage value Enr of a normalized voltage En that corresponds to the distance Dr (S16). Thereafter, the control device 31 generates calibration data 322a by using the voltage value Ei and the estimated voltage value E0, and stores the generated calibration data 322a in the storage device 32 (S17).

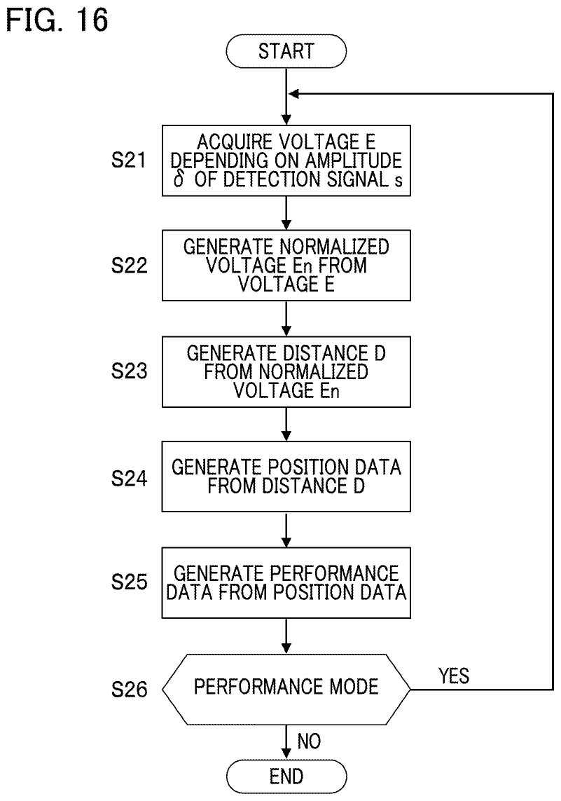

FIG. 16 is a flowchart showing an operation of the control device 31 in the playing mode. The operation of FIG. 16 is performed sequentially for each of the K keys 12 or in parallel for the K keys 12. First, based on the amplitude signal A, the control device 31 acquires a voltage E depending on an amplitude δ of the respective detected signal s (S21).

Next, the control device 31 calculates a normalized voltage En based on the voltage E by using the calibration data 322a (S22). Specifically, the control device 31 calculates the normalized voltage En by substituting the pair of constants p and q indicated by the calibration data 322a, and the voltage E, into Equation (7). At step S22, the control device 31 functions as the corrector 312a.

Next, the control device 31 uses the conversion data 322b, to generate a distance D from the normalized voltage En (S23). The conversion data 322b is data that associates normalized voltages En with distances D. Specifically, by referring to the conversion data 322b, the control device 31 generates a distance D that corresponds to the normalized voltage En generated at step S22. In a case in which the generated normalized voltage En is not recorded in the conversion data 322b, the control device 31 may calculate the distance D by interpolation.

Next, the control device 31 generates position data indicating a position Z of the key 12, based on the distance D (S24). Next, the control device 31 generates playing data from the position data (S25). The generated playing data is supplied to the sound source circuit 34. Thereafter, the control device 31 determines whether the operation is in the playing mode (S26). In a case in which a result of the determination at step S26 is affirmative, the control device 31 returns the process to step S21. In a case in which the determination result of step S26 is negative, the control device 31 ends the playing mode.

As described above, the keyboard musical instrument 100 according to the first embodiment includes a key 12 displaceable in accordance with a playing operation, a support member 14 that is not displaced in accordance with the playing operation, a detectable circuit 22 disposed on the key 12 and having a coil Lb, and a detector circuit 21 with a coil La disposed on the support member 14 and that outputs a detection signal s having an amplitude δ depending on the distance D between the detectable circuit 22 and the coil La. Here, the distance D in the first state in which no force caused by the playing operation acts on the key 12 is smaller than the distance D in the second state in which a force acts on the key 12. Thus, the distance D is the smallest in the first state. The amplitude δ of the detection signal s decreases as the distance D decreases. Accordingly, the amplitude δ of the detection signal s is small in a state in which the user does not press the key 12. Therefore, in the first state, unwanted radiation noise caused by the amplitude δ of the detection signal s can be minimized.

Furthermore, the keyboard musical instrument 100 according to the first embodiment includes the calibrator 311, which, based on the voltage E depending on the amplitude δ of the detection signal s in the first state, calibrates the correspondence data 322 indicating a correspondence between the voltage E and the position Z of the key 12, and a generator 312, which generates position data indicating the position of the key 12 based on the voltage E in the second state, by using the correspondence data 322 calibrated by the calibrator 311. Since the first state is a state in which no force caused by the playing operation acts on the key 12, the calibration is executed when the key 12 is in the rest position Zr. Therefore, the calibration can be executed when the user is not playing the instrument. For example, the calibrator 311 may calibrate the correspondence data 322 in a period from a time at which the power is turned on to a time at which the predetermined time has elapsed. In this period, since it is highly likely that the user is yet to start playing, the correspondence data 322 can be calibrated without the user being aware of the calibration. As a result, accuracy of the position data is improved by calibrating the variation in the voltage E due to the mounting positions of the detector circuit 21 and the detectable circuit 22. Further, by performing a calibration each time the power is turned on, it is possible to calibrate the variation in the voltage E due to temperature characteristics and aging of the detector circuit 21 and the detectable circuit 22.

In a case in which the K keys 12 are in the first state, the calibrator 311 calculates an average rest voltage value Era that is an average value of the voltages E for the K detection signals s output from the K detector circuits 21, and calibrates the correspondence data 322 based on the calculated average rest voltage value Era. Since the voltage value E0 need not be estimated for each rest voltage value Er, the processing load of the control device 31 can be reduced.

Further, it is easy to position the key 12 at the rest position Zr at which the distance D is the smallest within the movable range, and it is also easy to position the key 12 at the end position Ze at which the distance D is the largest within the movable range. Moreover, as shown in FIG. 11B, the voltage E at the rest position Zr is more sensitive to the deviation amount Δr than the voltage E at the end position Ze. Therefore, calibration accuracy is improved by calibrating the correspondence data 322 based on the rest voltage value Er, which depends on the amplitude of the detected signal s when the key 12 is in the rest position Zr.

Further, the calibrator 311 estimates, based on the rest voltage value Er corresponding to the rest position Zr, the voltage value E0 corresponding to the position Z of the key 12 when the distance D is zero, to calibrate the correspondence data 322 based on the estimated voltage value E0. The position Z of the key 12 when the distance D is zero (an example of a reference position) is closer to the coil La than the rest position Zr of the key 12 when the distance D is the smallest within the movable range. As shown in FIG. 11B, a voltage E in a case in which a key 12 is closer to the coil La than the rest position Zr is to the coil La is more sensitive to the deviation amount Δr. Accordingly, calibration accuracy is improved by calibrating the correspondence data 322 based on the estimated voltage value E0.

### B: Second Embodiment

The keyboard musical instrument 100 according to the first embodiment described above estimates the voltage value E0 shared by the detector circuits 21 based on (i) the voltage value Enr of the normalized voltage En corresponding to the rest position Zr and (ii) the average rest voltage value Era. Unlike the keyboard musical instrument 100 according to the first embodiment, the keyboard musical instrument 100 according to the second embodiment measures the voltage value Er of the voltage E corresponding to the rest position Zr for each detector circuit 21 and, based on the voltage value Er, estimates the voltage value E1 of the voltage E when the distance D is 1 mm. The keyboard musical instrument 100 according to the second embodiment is substantially the same as the keyboard musical instrument 100 of the first embodiment except for the estimation of the voltage value E1 in the calibrator 311. Hereinafter, focus will be on the differences in describing the keyboard musical instrument 100 according to the second embodiment.

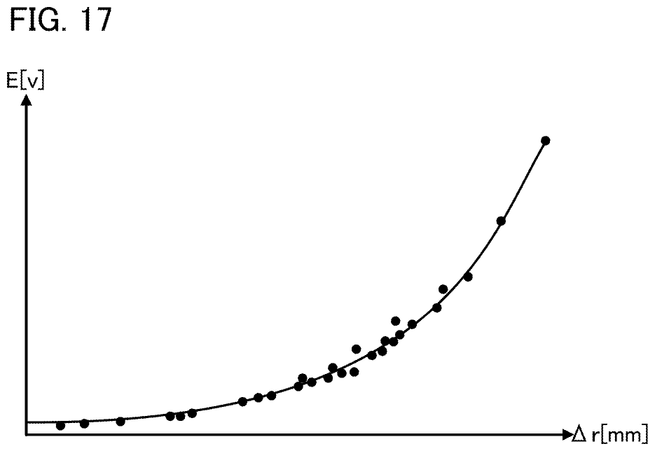

FIG. 17 is a graph showing a relation between the deviation amount Δr and the voltage E when the distance D between the coil La and the coil Lb is 1 mm. The deviation amount Δr indicates the distance between the central axis C1 of the coil La and the central axis C2 of the coil Lb in plan view, as described with reference to FIG. 11A. As shown in FIG. 17, when the distance D is 1 mm, the voltage E is dependent on the deviation amount Δr. Therefore, if the deviation amount Δr can be specified, it is possible to estimate the voltage E when the distance D is 1 mm. In the following description, the voltage value of the voltage E when the distance D is 1 mm is referred to as “E1.”

The voltage value E1 is sufficiently close to the voltage value E0 that it can be approximated to the voltage value E0. However, the voltage E1 is a voltage E when the distance D is 1 mm, and therefore is not actually measurable. Thus, it is necessary for the control device 31 to estimate the voltage value E1.

Next, a method of estimating the voltage value E1 will be described. The voltage value Er and the deviation amount Δr at the rest position Zr have a relation as approximately expressed in the following Equation (10).

Er=h2*Δr²+h1*Δr+h0 (10),
where h2, h1, and h0 are constants.

If the voltage value Er can be measured, the deviation amount Δr can be calculated by substituting the measured voltage value Er in the Equation (10). The approximate deviation amount Δr is given by Equation (11).

Δr=[−h1+{h1²−4(h0−Er)*h2}^{1/2}]/(2*h2) (11)

It is of note that the deviation amount Δr may be generated by storing in the storage device 32 a look-up table corresponding to the Equation (11) and referring to the look-up table.

Further, the approximate voltage value E1 is given by the following Equation (12).

E1=m4*Δr⁴+m3*Δr³+m2*Δr²+m1*Δr+m0 (12),
where m4, m3, m2, m1 and m0 are constants. The voltage value E1 is estimated as follows. First, the voltage value Er is measured in the first state, in which the key 12 is at the rest position Zr. Second, the deviation amount Δr is calculated by substituting the voltage value Er into Equation (11). Thirdly, the voltage value E1 is estimated by substituting the deviation amount Δr into the Equation (12). It is of note that a lookup table corresponding to the Equation (12) may be stored in the storage device 32, and the voltage value E1 may be generated by referring to the lookup table.

Next, the calibrator 311 according to the second embodiment will be described. Since the generator 312 is the same as that of the first embodiment in that position data is generated by using the calibration data 322a and the conversion data 322b, explanation thereof will be omitted. The calibrator 311 acquires the voltage value Er of the voltage E corresponding to each of the amplitudes δ of the K detected signals s in the first state in which the K keys 12 are located at the rest position Zr.

The calibrator 311 calculates the deviation amount Δr by substituting the voltage value Er into Equation (11). The calibrator 311 estimates the voltage value E1 by substituting the deviation amount Δr into Equation (12). Here, the normalized voltage En is given by Equation (13).

En=(E−E1)/(Ei−E1)

En=E/(Ei−E1)−E1/(Ei−E1)

En=p*E+q (13),
where p=1/(Ei−E1), q=−E1/(Ei−E1).

The calibrator 311 generates a pair of constants p and q as calibration data 322a for each detector 21, and stores the generated calibration data 322a in the storage device 32. Thus, the calibrator 311 calibrates the correspondence data 322 for each of the K keys 12 based on a voltage E that depends on the amplitude of each of the K detection signals s corresponding one-to-one with the K keys 12. As has been described above, in the keyboard musical instrument 100 according to the second embodiment, when the K keys 12 are in the first state and located at the rest position Zr, the calibrator 311 calibrates the correspondence data 322 for each of the K keys 12 based on the voltage E corresponding to the amplitude of each of the K detection signal s output from the K detector circuits 21. Therefore, a mounting error between the detector circuit 21 and the detectable circuit 22 can be calibrated for each key 12.

### C: Modifications

Examples of modifications that can be made to the embodiments described above will now be described. Two or more aspects freely selected from the following examples may be combined in so far as they do not contradict each other.
(1) In the above-described embodiments, the detectable circuit 22 includes a coil Lb constituted of conductors. However, the present disclosure is not limited thereto. The detectable circuit 22 may be configured in any manner as long as it acts on the magnetic field generated by the detector circuit 21. For example, the detectable circuit 22 may be made of a magnetic material. The detectable circuit 22 may be a plate-shaped conductor.
(2) In each of the above-described embodiments, an example is given of a configuration of detecting a displacement of a key 12 of the keyboard musical instrument 100, but the movable member for which the displacement is detected by the detection system 20 is not limited to the key 12. Examples of the movable member will now be described below.

### Form A

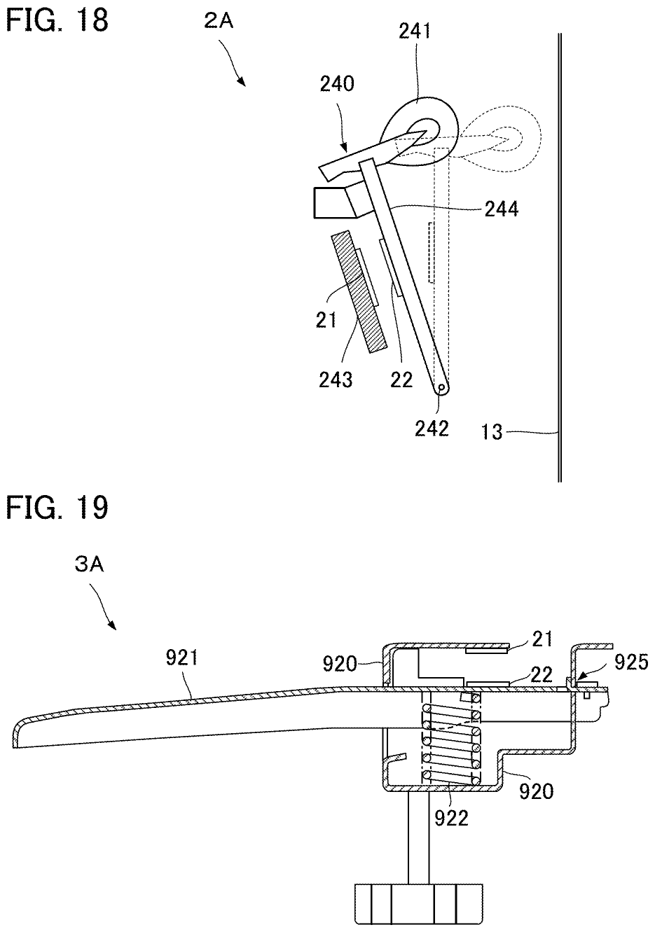

FIG. 18 is a schematic diagram of a configuration in which the detection system 20 is adopted to a strike mechanism 2A of the keyboard musical instrument 100. The strike mechanism 2A is an action mechanism that strikes a string 13 upon displacement of a key 12 of the keyboard 10. Specifically, the strike mechanism 2A includes, for each key 12, a hammer 240 that strikes the string by rotation, and a transmission mechanism (for example, a wippen, a jack, a repetition lever, or the like) that causes the hammer 240 to rotate in conjunction with the displacement of the key 12. The hammer 240 rotates around a support pin 242 that acts as a rotation axis. The rotation of the hammer 240 causes a hammer head 241 to strike the string 13. In the above configuration, the detection system 20 detects a displacement of the hammer 240. Specifically, the detectable circuit 22 is disposed in the hammer 240 (for example, in a hammer shank 244). The detector circuit 21 is disposed in a support member 243. Similarly to the above-described embodiments, in a case in which the key 12 is in the rest position Zr, the detector circuit 21 and the detectable circuit 22 are closest to each other in the strike mechanism 2A. In a case in which the key 12 is in the end position Ze, the detector circuit 21 and the detectable circuit 22 are farthest from each other. The support member 243 is, for example, a structure that supports the strike mechanism 2A. The hammer 240 is an example of a movable member that is displaceable within a movable range in accordance with a playing operation. The support member 243 is an example of a fixed member that is not displaceable in accordance with a playing operation. The strike mechanism 2A is provided for each key 12. Therefore, the keyboard musical instrument 100 includes K hammers 240 corresponding one-to-one with K keys 12. Therefore, in calibrating the detection system 20 (hammer sensor), if the same calibration as that of the above described respective embodiment is to be performed, the output voltage E of the detection system 20 may be measured for each key 12 in the rest position Zr, and the voltage value E0 may be estimated based on the average value of the measurements.

In the above-described configuration, since the key 12 and the hammer 240 move in conjunction with each other, the position for calibration is defined by the position of the stroke of the key 12, but may also be defined by the position of the hammer 240. In this case, for example, with the end position Ze being a position at which the string 13 and the head end of the hammer 240 are in contact with each other, and the rest position Zr being a position at which the hammer shank 244 is in contact with a hammer rail, an output value at the position at which the string 13 and the head end of the hammer 240 are in contact with each other is measured, and the voltage value E0 is estimated based on the average value of the measurements.

### Form B

FIG. 19 is a schematic diagram of a configuration in which the detection system 20 is applied to a pedal mechanism 3A of the keyboard musical instrument 100. The pedal mechanism 3A includes a pedal 921 operated by a user's foot, a frame 920 that supports the pedal 921, and an elastic member 922 that biases the pedal 921 vertically upward. The pedal 921 pivots about a fulcrum 925. In the above configuration, the detection system 20 detects a displacement of the pedal 921. Specifically, the detectable circuit 22 is disposed on the top surface of the pedal 921. The detector circuit 21 is disposed on a frame 920 provided above the pedal 921, to face the detectable circuit 22. In the pedal mechanisms 3A, similarly to the above-described embodiments, in the first state in which the user does not exert a force on the pedal 921, the detector circuit 21 and the detectable circuit 22 are closest to each other. In addition, in a state in which the user has depressed the pedal 921 to the maximum extent, the detector circuit 21 and the detectable circuit 22 are farthest from each other. The pedal 921 is an example of a movable member that is displaceable within a movable range in accordance with a playing operation. The frame 920 is an example of a fixed member that is not displaceable in accordance with a playing operation. It is of note that a musical instrument in which the pedal mechanism 3A is used is not limited to the keyboard musical instrument 100. For example, a pedal mechanism 3A with a similar configuration may be used for a musical instrument such as a percussion instrument. The detectable circuit 22 is disposed on the pedal 921 in this example, but the detectable circuit 22 may be disposed on a member connected to the pedal 921, and the detector circuit 21 may be disposed on the fixed member, to face the detectable circuit 22.

In the calibration according to this form, if the same calibration as that of the respective embodiment is to be performed, the voltage E is measured in the first state in which the user does not exert a force on the pedal 921, and the voltage value E0 may be estimated based on the measurement. In a case in which there is a plurality of pedals 921, the voltage value E0 may be estimated based on the average of the output values of each of the plurality of pedals 921.

Although the pedal mechanism 3A of the keyboard musical instrument 100 is illustrated in FIG. 19, the same configuration as that of FIG. 19 is adopted for a pedal mechanism used for an electric musical instrument such as an electric stringed musical instrument (for example, an electric guitar). A pedal mechanism used for an electric musical instrument is an effect pedal operated by a user to adjust various acoustic effects such as distortion or compression.

### Form C

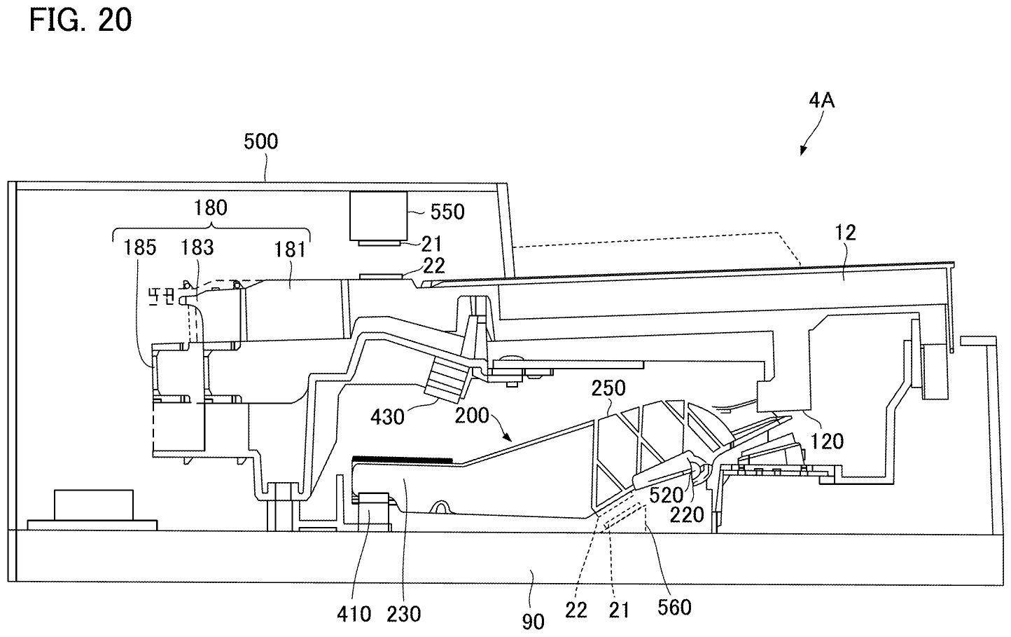

In each of the above-described embodiments, the detectable circuit 22 is disposed on the bottom surface of the key 12, while the detector circuit 21 is disposed so as to face the detectable circuit 22. However, the present disclosure is not limited thereto. FIG. 20 is a schematic diagram of a configuration in which the detection system 20 is applied to a keyboard mechanism 4A of the keyboard musical instrument 100.

The keyboard mechanism 4A includes a key 12, a connection part 180, a hammer assembly 200, and a frame 500. The frame 500 is fixed to a housing 90. The connection part 180 rotatably connects the key 12 to the frame 500. The connection part 180 includes a plate-shaped flexible member 181, a support part 183, and a rod-shaped flexible member 185. The plate-shaped flexible member 181 extends from the rear end of the key 12. The support part 183 extends from the rear end of the plate-shaped flexible member 181. The rod-shaped flexible member 185 is supported by the support part 183 and the frame 500. That is, the rod-shaped flexible member 185 is disposed between the key 12 and the frame 500. The rod-shaped flexible member 185 bends resiliently to allow the key 12 to pivot relative to the frame 500.

A pressing part 120 is connected to the key 12. The pressing part 120 rotates the hammer assembly 200 by being pressed in response to a rotation of the key 12. The hammer assembly 200 is disposed in a space below the key 12 and is rotatably mounted to the frame 500. The hammer assembly 200 includes a weighted portion 230 and a hammer body portion 250. Disposed on the hammer body portion 250 is a shaft support part 220 that serves as a bearing for the rotation shaft 520 of the frame 500. The shaft support part 220 and the rotation shaft 520 of the frame 500 are in slidable contact with each other at least at three points.

The weighted portion 230 includes a metal weight and is connected to a rear end portion of the hammer body portion 250 (to the back of the rotation shaft). In the normal state (when the key is not depressed), the weighted portion 230 sits on the lower stopper 410, and stabilizes the key 12 in the rest position. In response to a depression of the key, the weighted portion 230 moves upward and comes into contact with an upper stopper 430. This defines the end position, which is the maximum key depression amount of the key 12.

In the above configuration, the detection system 20 detects a displacement of the key 12. Specifically, the detectable circuit 22 is disposed on a top surface of a portion of the key 12, the portion being located inside the frame 500. On the other hand, the detector circuit 21 is disposed on a bottom surface of a pedestal 550 provided on the inner peripheral surface of the frame 500. In the keyboard mechanism 4A, similarly to the above-described embodiments, when the key 12 is in the rest position Zr, the detector circuit 21 and the detectable circuit 22 are closest to each other. When the key 12 is in the end position Ze, the detector circuit 21 and the detectable circuit 22 are farthest from each other. The pedestal 550 is an example of a fixed member that is not displaceable in accordance with a playing operation. The key 12 is an example of a movable member that is displaceable within a movable range in a playing operation. As shown by the dotted line in FIG. 20, the detector circuit 21 may be disposed on a pedestal 560 provided in the housing 90, and the detectable circuit 22 may be disposed on the lower surface of the hammer body portion 250.

In each of the above-described embodiments, an example is given of a configuration for detecting the key 12 of the keyboard musical instrument 100. However, the detection target of the detection system 20 is not limited to the above-described examples. For example, an operator operated by a user when playing a wind instrument such as a woodwind instrument (for example, a clarinet or a saxophone) or a brass instrument (for example, a trumpet or a trombone) may be detected by the detection system 20.

As will be understood from the above examples, an object to be detected by the detection system 20 is a movable member that is displaceable in accordance with a playing operation. The movable member includes a playing operator such as a key 12 or a pedal 921 directly operated by a user, and a structure such as a hammer 240 that is displaceable in conjunction with an operation carried out on the playing operator. However, the movable member in the present disclosure is not limited to a member that is displaceable in accordance with a playing operation. That is, the movable member is a member that is displaceable regardless of how the displacement is caused.
(3) In the above-described embodiments, the keyboard musical instrument 100 includes the sound source circuit 34. However, the sound source circuit 34 may be omitted, for example, in a configuration in which the keyboard musical instrument 100 includes a sound generating mechanism such as a strike mechanism 2A or 2B. The detection system 20 may be used to record playing of the keyboard musical instrument 100.

As will be understood from the above explanation, the present disclosure is also specified as a device (operation device) that controls a music sound by outputting to the sound source circuit 34 or to the sound generating mechanism an operation signal that corresponds to a playing operation. In addition to a musical instrument (the keyboard musical instrument 100) including the sound source circuit 34 as set out in the above-described embodiments or the sound generating mechanism, a device (for example, a MIDI controller or the above-described pedal mechanism 3A and 3B) not including the sound source circuit 34 or the sound generating mechanism is included within the concept of the operation device. That is, a musical instrument playing apparatus in the present disclosure is comprehensively defined as a device that is operated by a player (operator) for playing.

### D: Appendices

As examples, the following aspects are derivable from the embodiments above.

A musical instrument according to an aspect (Aspect 1) of the present disclosure includes a fixed member; a movable member displaceable in response to a playing operation of the musical instrument, the movable member being displaceable relative to the fixed member from a first state where the movable member is in an initial position to a second state where the movable member is displaced from the initial position; a detectable circuit including a magnetic or conductive body and disposed on the movable member; and a detector circuit including a coil disposed on the fixed member and configured to output a detection signal corresponding to a voltage that is dependent on a distance between the detectable circuit and the coil, in which a distance between the detectable circuit and the coil in the first state is smaller than a distance between the detectable circuit and the coil in the second state. The distance D in the first state in which the force caused by the playing operation does not act on the movable member is smaller than the distance in the second state in which the force acts on the movable member. That is, the distance is the smallest in the first state (Aspect 2). The amplitude of the detection signal decreases as the distance decreases. Therefore, the amplitude of the detection signal is small in a state in which the movable member is not depressed by the user. Consequently, in the first state, unwanted radiation noise caused by the amplitude of the detection signal can be reduced.

A musical instrument according to an aspect (Aspect 3) of the present disclosure further includes: one or more memories storing instructions; and one or more processors that implement the instructions to perform: a calibrating task that calibrates, based on the voltage of the detection signal in the first state, correspondences between voltages of detection signals and positions of the movable member; and a generating task that generates position data indicating a position of the movable member based on the voltage of the detection signal in the second state, using the calibrated correspondences.

In a musical instrument according to an aspect (Aspect 4) of the present disclosure, the calibrating task calibrates the correspondences in a period from a time at which power of the musical instrument is turned on to a time at which a predetermined time elapses. Since within this period it is highly unlikely that the user will start playing, the correspondence can be calibrated without the user being aware of the calibration. As a result, accuracy of the position data is improved by calibrating a variation in voltage arising from deviations in mounting positions of the detector circuit and the detectable circuit. Further, by performing calibration each time the power is turned on, it is possible to calibrate a variation in voltage arising from temperature characteristics and aging of the detector circuit and the detectable circuit.

The musical instrument according to one aspect (Aspect 5) of the present disclosure further includes K movable members, including the movable member, where K is an integer of 2 or more, each displaceable within a movable range in response to the playing operation; K detectable circuits, including the detectable circuit, corresponding one-to-one with the K movable members, in which the K detectable circuits are disposed on the K movable members corresponding one-to-one with the K detectable circuits; and K detector circuits, including the detector circuit, corresponding one-to-one with the K detectable circuits, in which the calibrating task, while each of the K movable members is in the first state, calculates an average value of K voltages for K detection signals output from the K detector circuits, to calibrate the correspondences based on the calculated average value of the K voltages. According to this aspect, since the correspondence is calibrated based on the average value of the voltages, it is possible to reduce the processing load related to the calibration. In the musical instrument according to an aspect (Aspect 6) of the present disclosure, it is preferable that the K movable members are K keys constituting a keyboard of the musical instrument (for example, piano keys). According to this aspect, it is possible to calibrate variations due to arising from the deviations in the mounting positions of the K piano keys.

In a musical instrument according to an aspect (Aspect 7) of the present disclosure, it is preferable that the musical instrument further includes K piano keys, and the K movable members are K hammers corresponding one to one with the K piano keys. According to this aspect, it is possible to calibrate variations due to the mounting positions of the K hammers.

In the musical instrument according to an aspect (Aspect 8) of the present disclosure, it is preferable that the movable member is one of a pedal or a member connected to the pedal. According to this aspect, it is possible to calibrate a variation arising from the deviations in the mounting position of the pedal or the member connected to the pedal.

### DESCRIPTION OF REFERENCE SIGNS

100 . . . keyboard musical instrument, 10 . . . keyboard, 12 . . . key, 121 . . . end portion, 122 . . . installation surface, 14 . . . support member, 20 . . . detection system, 21 . . . detector circuit, 211 . . . resonance circuit, 22 . . . detectable circuit, 221 . . . resonance circuit, 23 . . . drive circuit, 30 . . . information processing apparatus, 31 . . . control device, 32 . . . storage device, 34 . . . sound source circuit, 40 . . . sound output apparatus.

What is claimed is:

1. A musical instrument comprising:
a fixed member;
a movable member displaceable in response to a playing operation of the musical instrument, the movable member being displaceable relative to the fixed member from a first state where the movable member is in an initial position to a second state where the movable member is displaced from the initial position;
a detectable circuit including a magnetic or conductive body and disposed on the movable member; and
a detector circuit including a coil disposed on the fixed member and configured to output a detection signal corresponding to a voltage that is dependent on a distance between the detectable circuit and the coil,
wherein a distance between the detectable circuit and the coil in the first state is smaller than a distance between the detectable circuit and the coil in the second state.

2. The musical instrument according to claim 1, wherein the distance between the detectable circuit and the coil is smallest in the first state.

3. The musical instrument according to claim 1, further comprising:
one or more memories storing instructions; and
one or more processors that implement the instructions to perform:
a calibrating task that calibrates, based on the voltage of the detection signal in the first state, correspondences between voltages of detection signals and positions of the movable member; and
a generating task that generates position data indicating a position of the movable member based on the voltage of the detection signal in the second state, using the calibrated correspondences.

4. The musical instrument according to claim 3, wherein the calibrating task calibrates the correspondences in a period from a time at which power of the musical instrument is turned on to a time at which a predetermined time elapses.

5. The musical instrument according to claim 3, further comprising:
K movable members, including the movable member, where K is an integer of 2 or more, each displaceable within a movable range in response to the playing operation;
K detectable circuits, including the detectable circuit, corresponding one-to-one with the K movable members, wherein the K detectable circuits are disposed on the K movable members corresponding one-to-one with the K detectable circuits; and
K detector circuits, including the detector circuit, corresponding one-to-one with the K detectable circuits,
wherein the calibrating task, while each of the K movable members is in the first state, calculates an average value of K voltages for K detection signals output from the K detector circuits, to calibrate the correspondences based on the calculated average value of the K voltages.

6. The musical instrument according to claim 5, wherein the K movable members are K keys constituting a keyboard of the musical instrument.

7. The musical instrument according to claim 5, further comprising:
K piano keys, and
wherein the K movable members are K hammers corresponding one to one with the K piano keys.

8. The musical instrument according to claim 1, wherein the movable member is one of a pedal or a member connected to the pedal.
